(19) United States
(12) Patent Application Publication
(10) Pub. No.: US 2024/0060900 A1
(43) Pub. Date: Feb. 22, 2024

(54) THREE DIMENSIONAL MOLECULAR IMAGING THROUGH HOMOGENIZED COHERENT EXCITATION

(71) Applicant: INDIAN INSTITUTE OF SCIENCE, Bangalore (IN)

(72) Inventors: Siva UMAPATHY, Bangalore (IN); Sanchita SIL, Bangalore (IN); Dipak KUMBHAR, Bangalore (IN); R Vishnu KUMAR, Bangalore (IN)

(21) Appl. No.: 18/269,558

(22) PCT Filed: Dec. 22, 2021
(86) PCT No.: PCT/IN2021/051199

§ 371 Date: Jun. 25, 2023

(30) Foreign Application Priority Data
Dec. 24, 2020 (IN) 202041056364

(51) Int. Cl. G01N 21/65; G01J 3/44

(52) U.S. Cl. CPC G01N 21/65; G01J 3/4412; G01N 2201/06113; G01N 2201/0631

(57) ABSTRACT

The method includes homogenizing a monochromatic coherent light source, irradiating the sample at plurality of points along all planes with the homogenized monochromatic light, collecting the molecular scattered light from all angles and planes to obtain a plurality of profile, resolving the plurality of profiles to obtain a molecular intensity maps, and reconstituting the intensity maps to obtain a three dimensional image of the sample. The system described is capable of obtaining molecular specific 3D morphology and profile of samples. The system described is capable of differentiating different chemicals or sample distribution throughout the 3D volume.

### FIELD OF INVENTION

The invention generally relates to the field of physical chemistry and particularly to a method and a system for three dimensional molecular imaging through homogenized coherent excitation of a sample.

### BACKGROUND

Three dimensional imaging provides valuable information regarding shape and size of a sample. Various techniques available in the art for three dimensional imaging include but are not limited to computerized tomography, tuned-aperture computed tomography, optical coherence tomography, photo acoustic tomography and magnetic resonance imaging. Computerized tomography uses special X-ray equipment to generate cross-sectional images of the sample under study. One significant disadvantage of the technique is that the use of X-ray makes the technique unsuitable for the bio-imaging. Optical coherence tomography performs high-resolution, cross-sectional tomographic imaging of a sample by measuring backscattered or back reflected light. Photo acoustic tomography, sometimes referred to as opto-acoustic tomography, performs three-dimensional imaging of a material based on the photo acoustic effect. Optical coherence tomography and photo acoustic tomography enable three dimensional imaging of a sample in multiple scattering media. Magnetic resonance imaging is based on excitation and detection of the change in the direction of the rotational axis of protons found in the water of the living tissue.

One significant disadvantage of the abovementioned optical imaging techniques is that the depth till which a sample can be imaged is limited to up to 1-2 cm. Another disadvantage is that these techniques provide only morphological information of the sample. Yet another disadvantage of the abovementioned techniques is that the light used for irradiation of the sample is of high power and ionizing radiation. High power of the irradiation light results in local heating leading to sample degradation. The degradation of sample may lead to error in the analysis of the sample. Ionizing radiation may be harmful for in vivo imaging.

Thus, there is a need for a method for three dimensional imaging of the sample which is nondegradable, provides chemical information along with morphological information of the sample and is able to image samples placed deeper into the multiple scattering media.

### BRIEF DESCRIPTION OF DRAWINGS

So that the manner in which the recited features of the invention can be understood in detail, some of the embodiments are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a system for three dimensional molecular imaging through homogenized coherent excitation of a sample, according to an embodiment of the invention.

FIG. 2 shows a collection arrangement for collecting a Molecular Scattered light, according to one example of the invention.

FIG. 3a shows an experimental setup for obtaining three dimensional profile of an ammonium nitrate concealed inside a chicken tissue, according to an example of the invention.

FIG. 3b shows a Molecular intensity map at a particular Raman frequency of the ammonium nitrate, according to an example of the invention.

FIG. 3c shows an isometric three dimensional view of shape reconstruction of the ammonium nitrate, according to an example of the invention.

FIG. 4a shows an experimental setup for obtaining three dimensional profile of a dicyanobenzene and a trans-stilbene pellet concealed inside an agar based tissue phantom, according to another example of the invention.

FIG. 4b shows a Molecular intensity map of the dicyanobenzene and the trans-stilbene at a particular Raman frequency, according to another example of the invention.

FIG. 4c shows an isometric three dimensional view of shape reconstruction of the dicyanobenzene and the trans-stilbene pellet embedded inside the agar based optical tissue phantom, according to another example of the invention.

### SUMMARY OF THE INVENTION

One aspect of the invention provides a method for three dimensional molecular imaging through homogenized coherent excitation of a sample. The method includes homogenizing a monochromatic coherent light source, irradiating the sample at plurality of points along all planes with the homogenized monochromatic light, collecting the molecular scattered light from all angles and planes to obtain a plurality of profile, resolving the plurality of profiles to obtain a cross-sectional image, and reconstituting the image to obtain a three dimensional image of the sample.

Another aspect of this invention highlights the collected Raman profiles are independent of the point of illumination. The system includes a monochromatic coherent light source, an arrangement for homogenizing the monochromatic coherent light, a sample holder, a collection arrangement and an analyser.

### DETAILED DESCRIPTION OF THE INVENTION

All the terms mentioned in the description herein shall be interpreted in their usual and standard meaning unless otherwise specified. Various embodiments of the invention provide a method for three dimensional molecular imaging through homogenized coherent excitation of a sample. The method for homogenized coherent excitation of a sample includes homogenizing the monochromatic coherent light; irradiating the sample with the homogenized monochromatic light; collecting the Molecular scattered light about 4π angles and about 4π planes to obtain a plurality of profiles. Resolving the plurality of profiles to obtain a three dimensional image of the sample. The method described herein above in brief shall be described in detail.

The method works on the principle of using a homogenized light source to illuminate the sample without altering the coherence of the light source. The monochromatic coherent light source includes but is not limited to a laser, a diode laser or any other light source with a wavelength from UV-VIS to INFRARED. In one embodiment of the invention, the monochromatic coherent light source is near infrared laser. In one embodiment of the invention, the wavelength of the monochromatic coherent light source is 830 nm. The advantages of selecting the near infrared lasers includes but not limited to investigating strongly scattering media due to the absence of fluorescence, very less absorption and provides better penetration depth.

Subsequent to selection, the monochromatic coherent light is homogenized. The homogenization of the monochromatic coherent light is achieved by using an arrangement of suitable optical components such as lenses and mirrors to diffuse the monochromatic collimated coherent light to cover a large area of the sample. The homogenized monochromatic coherent light obtained is a low power density monochromatic coherent light to avoid sample damage.

The homogenized monochromatic light with the low power as obtained herein is used for irradiating the sample. The advantage of irradiating the sample with the homogenized monochromatic light includes but is not limited to, coverage of more sample area, multiple scattering, deeper penetration inside the sample, increased generation of molecular photons from the sample, low power density on the sample, reduced sample damage and amplification of molecular signal. In one example of the invention, the scattered photons from the sample is collected at a step size of about 100 μm vertically and at about 4° rotation for each plane. The collection angle of the molecular scattered light is independent of the angle of irradiation of the sample. The molecular scattered light is collected about 4π angles and about 4π planes to obtain a plurality of profiles. The plurality of profiles obtained are reconstituted to obtain a three dimensional image of the sample. Examples of the sample include but are not limited to chemical contaminants, tissue contaminants, modified tissues, degenerated tissues, tumours and objects capable of providing a chemical signature.

Various embodiments of the invention also provide a system for three dimensional molecular imaging through homogenized coherent excitation of a sample. The system includes a monochromatic coherent light source, an arrangement for homogenizing the monochromatic coherent light placed proximal to the monochromatic coherent light source, a sample holder, a collection arrangement positioned at various angles around the sample and an analyzer operatively coupled to the collection arrangement.

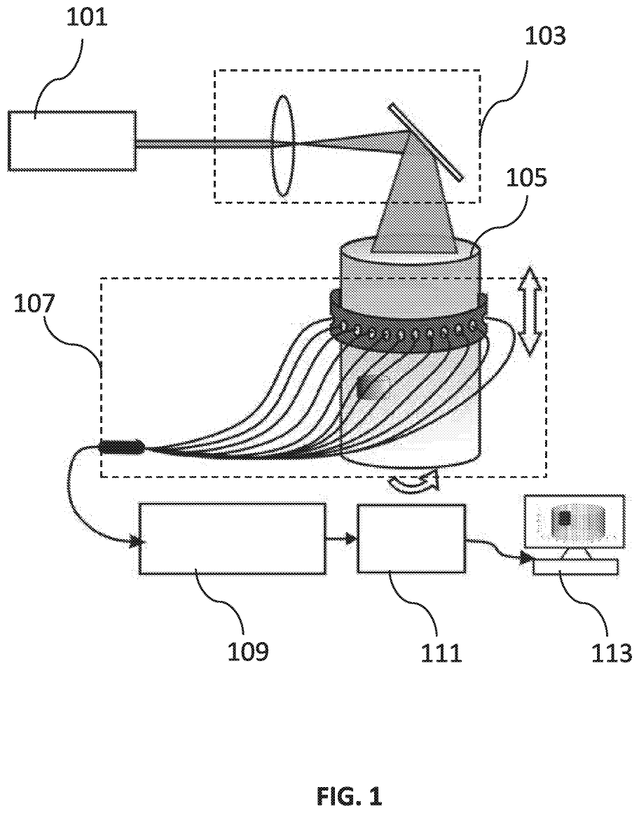

FIG. 1 shows a system for three dimensional molecular imaging through homogenized coherent excitation of a sample, according to an embodiment of the invention. The system includes a monochromatic coherent light source 101. In one example of the invention, a near infrared laser is selected as the monochromatic coherent light source. An arrangement for homogenization 103 is positioned coaxial to the monochromatic coherent light source 101. The homogenized monochromatic light obtained is used to irradiate the sample 105 at different locations. The molecular scattered light is collected using a collection arrangement 107. An analyzer is operatively coupled to the collection arrangement 107. The analyzer includes a spectrometer 109, a detector 111 and an analysis unit 113. The spectrometer 109 is connected to a detector 111. The output of the detector 111 is sent to the analysis unit 113.

Each of the components mentioned herein above briefly shall be explained in detail as examples of the invention.

In one embodiment of the invention, the monochromatic coherent light source 101 is near infrared laser. The wavelength of monochromatic coherent light source 101 is in the range of 300 nm to 1400 nm. In one example of the invention, the wavelength of the monochromatic coherent light source 101 is chosen to be 830 nm. The monochromatic coherent light source 101 is then homogenised. Examples of arrangement for homogenization 103 include but are not limited to mirror lens arrangement, multiple reflection arrangement, on all combination of light source dispersed using optics. The homogenized monochromatic light obtained by the arrangement described herein is used to irradiate the sample 105 at different locations. The molecular scattered light is then collected using a collection arrangement 107.

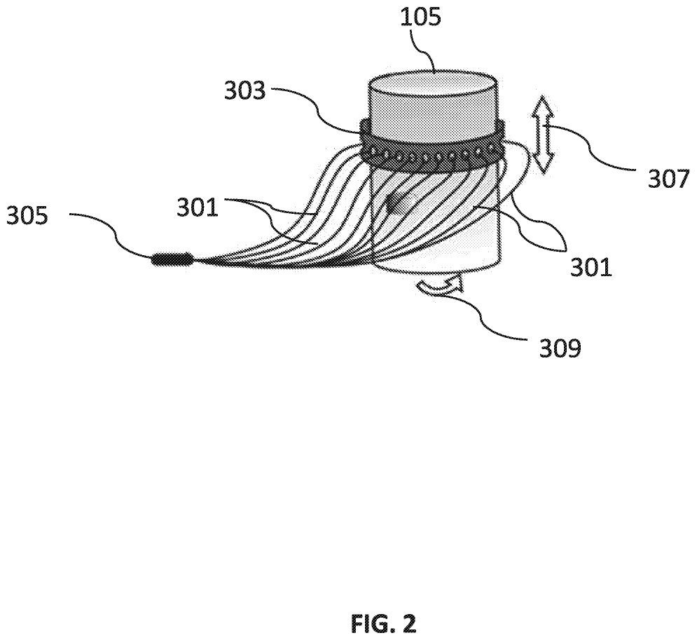

FIG. 2 shows a collection arrangement for collecting the molecular scattered light. The collection geometry is independent of the excitation geometry. Hence the molecular scattered light obtained is collected about 4π angles and about 4π planes. The collection arrangement 107 is a plurality of collection lenses, a plurality of optical fibers or a combination thereof. In one example of the invention the collection arrangement includes a plurality of optical fibers 301; an optical fiber holder 303; an optical fiber coupler 305; means for translation of the collection arrangement 307 about various axes and means for rotation of the collection arrangement 309. For example; either the sample or the collection fibers can be rotated by less than 1° per step to 360°. In one example of the invention, twenty optical fibers with the same core diameter are placed equally at 18° separation around the sample 105. The optical fiber holder 303 is a rotatable circular disc. The step size for translation of the collection arrangement 107 is about 100 μm. The step size for rotation of the collection arrangement is about 4°. The maximum vertical resolution obtained in this embodiment is 10 μm. The maximum angular resolution obtained in this embodiment is 4°. The maximum achievable vertical and angular resolution is 1 μm and 0.1° respectively. The optical fibers 301 are bundled through the optical fiber coupler 305 and placed in front of the entrance slit of a spectrometer 109. The spectrometer 109 then analyses the molecular scattered light and sends it to the detector. Examples of the detector include but are not limited to charge coupled devices (CCD), photomultiplier tube (PMT), diode array, or avalanche photodiode (APD). In one example of the invention, the detector is liquid nitrogen (LN₂) cooled CCD. The output of the detector 111 is sent to an analysis unit 113. The analysis unit 113 includes a reconstruction module. In one example of the invention, the reconstruction module is implemented using commercially available MATLAB code to generate a 3D profile of the sample.

For a 4° angular resolution, 5 CCD images are recorded at every 4° rotation i.e. 0°, 4°, 8°, 12°, 16° so on up to 360°. The obtained CCD images are preprocessed using software LABSPEC. The processing of the images is done to remove noise. A median filter is used to remove cosmic ray spikes of CCD image. Further, the CCD image is smoothened using average filter. The smoothening of the CCD image is done to remove CCD readout noise; photon shot noise and dark current noise. After image processing and image smoothing the size of the CCD image obtained is 251×992 Pixels. The CCD images obtained are imported into MATLAB R2014b software for further processing. After the processing step, the CCD image is deconvoluted to extract spectra for individual detector. A range of pixel values are averaged for the spread of intensity for each collection fiber on the CCD image. Averaging of pixels improves signal strength and removes random noise present in the signal. This process is iterated for all the fibers at each location.

Removal of baseline is done using polynomial fitting of 5° followed by filter using Savitzky Golay filter to smooth the spectral data without losing shape of small peaks. Specific peak intensity values are extracted from each spectra corresponding to a molecular signatures from different layers of the sample. Each slice with 4° resolution with 5 rotations gives 100 spectra. If the sample height is 8 cm with a vertical resolution of 100 μm, the total numbers of spectra processed are 800×100=80000. The intensity values from each spectrum are mapped to respective pixel to form an image. The intensity values show the intensity variation along angle and height of the sample. The intensity variation gives depth information of the sample concealed inside a tissue.

Data from each height is extracted to find the location of the molecular scattered light. The obtained data from each height is then imported into the reconstruction module. The reconstruction module converts data from each height into a cross-sectional image. Multiple cross-sectional images are stacked together to form a 3D data matrix. The 3D matrix is further processed to obtain volumetric information of the sample of interest.

The method and the system as described in detail herein above is applied to determine shapes of samples, concealed within another translucent or opaque sample. Examples of surrounding medium include but are not limited to animal meat, containers, boxes, tubes and the like. Further, these samples are hidden at various depths within the surrounding medium to demonstrate the penetration ability of the method disclosed. The examples provided herein below are only to demonstrate the functioning of the method and the system. The examples are provided as representative examples and are not to be construed as limiting the scope of the invention. It is obvious to a person skilled in the art to adapt the method and system including the variations described to determine shapes of various other samples.

### Example 1

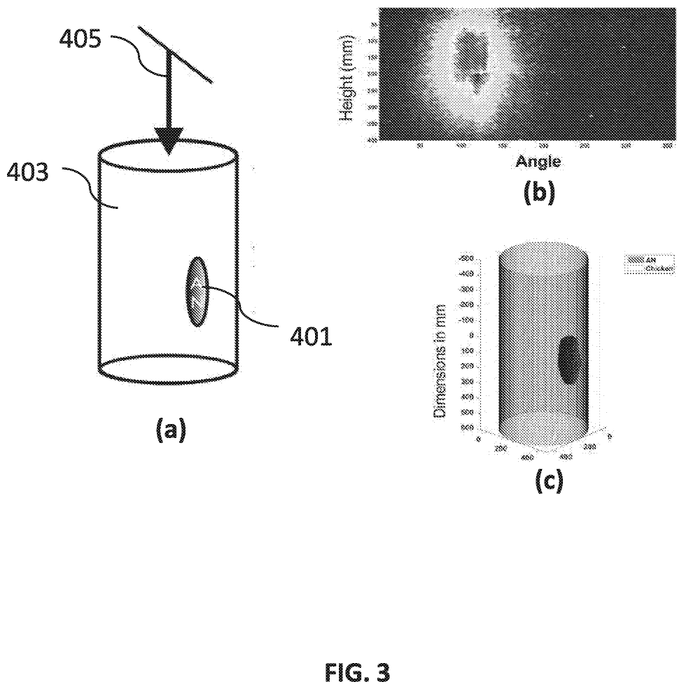

In one example of the invention, the method and the system, as described hereinabove, is applied for detection of a concealed sample. In one example of the invention the concealed sample is ammonium nitrate. FIG. 3 shows an experimental setup for obtaining three dimensional profile of an ammonium nitrate concealed inside a chicken tissue. The ammonium nitrate 401 is filled in an ellipse-shaped glass container. The dimension of the ellipsoid has a major axis of 3.5 cm and minor axis of 1 cm. The filled container is concealed inside a chicken tissue 403 at 5.5 cm depth from the surface of the chicken breast tissue. The chicken breast tissue is molded into a cylindrical shape. The chicken breast tissue 403 with embedded ammonium nitrate 401 is irradiated with homogenized monochromatic light 405. The molecular scattered light is collected to obtain an intensity map. FIG. 3b shows the molecular intensity map of ammonium nitrate at 1040 cm⁻¹. The intensity distribution reveals the location of the concealed sample at particular height and at particular angle of the concealed sample. FIG. 3c shows an isometric three dimensional view of shape reconstruction of the ammonium nitrate. The shape reconstruction of the ammonium nitrate is examined to be identical to the actual ammonium nitrate sample.

### Example 2

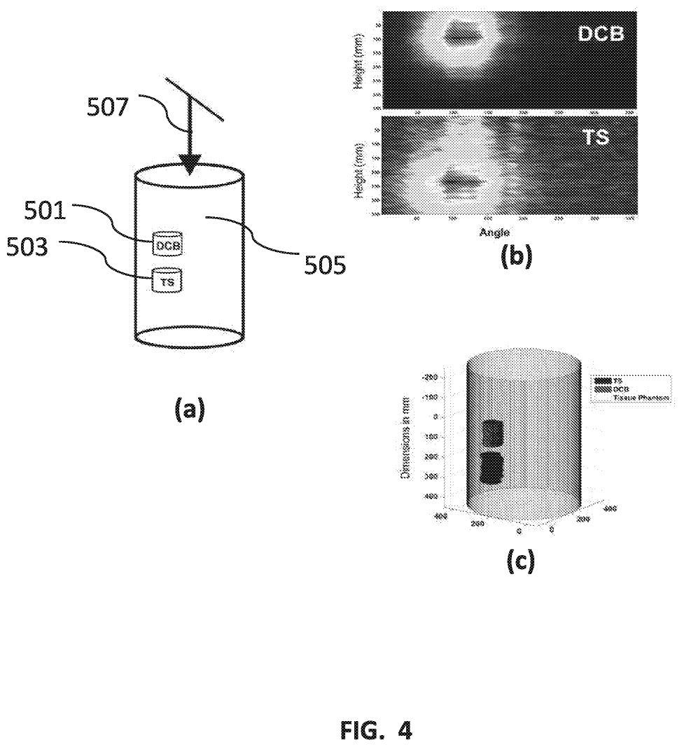

According to another example of the invention, the method and the system, as described hereinabove, is applied for differentiating the two different concealed samples. In one example of the invention, one of the concealed sample is trans-stilbene and the other concealed sample is dicyanobenzene (DCB). FIG. 4a shows an experimental setup for obtaining three dimensional profile of the dicyanobenzene and the trans-stilbene concealed inside an agar based optical phantom tissue. The dicyanobenzene pellet 501 is vertically placed on top of the trans-stilbene pellet 503. The pellets are separated by a distance of 5 mm. The size of each pellet is approximately 1 cm in height and 1 cm in diameter. The dicyanobenzene pellet 501 is placed on top at a height of 3 cm away from the surface of the agar based optical phantom 505. The trans-stilbene pellet is placed approximately 5 mm vertically below the DCB pellet. The dicyanobenzene pellet 501 and trans-stilbene pellet 503 contained within the optical phantom are irradiated with homogenized monochromatic light 507. The agar based phantom is scanned for a total height of 3.5 cm vertically with a step size of 100 μm and an angular resolution of 4° per scanned height. The molecular scattered light is collected to obtain a molecular intensity map. FIG. 4b shows the molecular intensity map of the dicyanobenzene at 1172 cm⁻¹ peak and the molecular intensity map of the trans-stilbene at 1192 cm⁻¹. Further, FIG. 4c shows an isometric three dimensional view of shape reconstruction of the trans-stilbene and the dicyanobenzene.

The invention provides a method for obtaining 3D imaging of samples through homogenized excitation. The invention also provides a system for enabling the method described. One significant advantage of the method is that the method is non invasive. Further, the homogenized light adapted for illuminating the sample has a low power density. The low power density of the incident light prevents degradation of the sample, thereby enabling re-use of the sample. The method and the system as provided by the invention can be adapted to detect shapes of objects at a depth in the range of about 60 mm to about 90 mm. The applications of the method and the system, as described hereinabove include but are not limited to determining bone related disorders, detecting cancer, differentiating the types of malignant tissues, detection of hazardous chemicals, contaminants and all objects capable of providing a chemical signature.

The foregoing description of the invention has been given merely to illustrate the invention and is not intended to be limiting. Since modifications of the disclosed embodiments incorporating the spirit and substance of the invention may occur to a person skilled in the art, the invention should be construed to include everything within the scope of the appended claims and equivalents thereof.

We claim:

1. A method for three dimensional molecular imaging through homogenized coherent excitation of a sample, the method comprising:
irradiating the sample at a plurality of points with a predetermined step size at a predetermined rotation along 4π planes with the homogenized coherent light source;
obtaining a plurality of Raman profile light from 4π angles and 4π planes;
resolving the plurality of profiles to obtain a three dimensional image of the sample.

2. The method as claimed in claim 1, wherein the wavelength of the monochromatic light source is in the range of 300 nm to 1400 nm.

3. The method as claimed in claim 1, wherein the step size for irradiation is about ≥1 μm vertically for each plane.

4. The method as claimed in claim 1, wherein the predetermined rotation during irradiation is about ≥0.1° for each plane.

5. The method as claimed in claim 1, wherein the collection angle is independent of the point and angle of illumination.

6. The method as claimed in claim 1, wherein the sample is selected from a list comprising of chemical contaminants, tissue contaminants, modified tissues, degenerated tissues, tumours and objects capable of providing a chemical signature.
